(19) United States
(12) Patent Application Publication
(10) Pub. No.: US 2002/0169666 A1
(43) Pub. Date: Nov. 14, 2002

(54) Ordering-and-reserving management method using paper medium attached with unique code and advertising effect analysis method and system thereof

(75) Inventors: Masayuki Ike, Tokyo (JP); Masakazu Ito, Tokyo (JP); Takeshi Suzuki, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/006,685

(22) Filed: Dec. 10, 2001

Related U.S. Application Data
(63) Continuation-in-part of application No. 09/949,381, filed on Sep. 6, 2001.

(30) Foreign Application Priority Data
May 10, 2001 (JP) 2001-140494

(51) Int. Cl. G06F 17/60

(52) U.S. Cl. 705/14

(57) ABSTRACT

A method including, a code-receiving procedure (s101) for receiving the unique code of the paper medium (50) from a reader terminal (30); a code-authentication procedure (s102) authenticating the validity of the unique code by performing, regarding the received unique code from the reader terminal (30), corresponded with the paper medium 50 and authenticated in a data base (10a) recorded with the unique code, or by requesting authentication to an issuing-and-certification authority which is the origin of the unique code and obtaining the results; individual-specific-information-receiving procedure (s106) receiving from the reader terminal (30), an event of ordering-and-reserving demands of the customer regarding the printed products/services printed on the paper medium (50) presented by the consumer through a reader terminal (30) and an individual-specific information which may specify the consumer; a paper medium-ticketing procedure (s110) corresponding the consumer specified by the individual specific information together with the unique code authenticated by the code-authentication procedure (s102) in the database (10a), as well as recording that the ordering-and-reserving demand of the consumer regarding the printed products and services of the paper medium (50) attached with the unique code has been received; and a result-sending procedure (s111) for sending the result of ticketing to the reader terminal (30) in the paper medium ticketing procedure (s110).

This is a continuation-in-part application of U.S. patent application Ser. No. 09/949,381 filed on Sep. 6, 2001. U.S. patent application Ser. No. 09/949,381, and Japanese Patent Application No. 2001-140494 filed on May 10, 2001, upon which the present application and the parent application claim priority, are incorporated herein by reference.

### BACKGROUND OF THE INVENTION

1. Field of the Invention

The present invention relates to a method of managing with a server computer ordering and reserving of printed products/services, by using a paper medium such as a pamphlet, a catalogue or a leaflet printed with advertising information regarding such as products/services and attached with a unique code, which is directed for the many and unspecified consumers.

2. Description of the Related Art

Paper mediums for advertisement requesting purchase of a product/service directed for the many and unspecified consumers, such as a folded advertisement inserted in between a newspaper, a travel pamphlet or a concert poster placed outside a shop, and a mail order catalogue, have become very common. Due to the ease of distributing and manufacturing, and low cost of this paper medium, and also from the view of its popularization and establishment of its method of use, this medium is used in various industries, and general consumers often look at it with ease in the streets or at home.

However, if a consumer wishes to perform procedures for ordering and reserving a printed product/service based on information printed on a space of the paper medium, in the end it is necessary to actually go to a shop to perform the procedures, or to phone himself/herself and perform the procedures after listening to such as a product explanation.

Accordingly, for example, paying attention to the procedures of ticket reserving/ticket issuing, there is developed a technique to simplify this by use of an IC card. As such a technique, for example there is a conventional example as shown in Japanese Patent Application Laid-open Publication No. 10-134129. This technique has an aim to solve complications of the consumer reserving a ticket in advance by such as a telephone or the Internet and obtaining a reservation number and then settling a payment at an actual shop such as a ticket counter based on this reservation number, and a problem of the need of a ticket issuing agent to arrange attendants or shops to cope with the above. The technique is characterized in that by writing in reservation information or ticket information given from the ticket issuing agent on the IC card which the consumer has, this IC card becomes a medium of electronic ticket issuing.

However, in the above conventional technique, even if electronic ticket issuing is possible, the medium is always an IC card, and is not a paper medium printed with an advertisement. Therefore, for example, if a consumer takes and looks at a concert pamphlet on the street, and tries to reserve/buy the concert ticket, if that consumer does not own an IC card, reservation and purchasing has to be performed in the conventional procedures. That is, the electronic ticket reservation and possibility of the ticket issuing is influenced by whether or not the consumer has an IC card, and therefore it may not be a fundamental solution to simplify the ordering and reserving procedures related to the above described products/services. Of course, it is obvious that consumers without an IC card are lessened of their interest to purchase, further a problem may arise that since the ticket information recorded in the IC card is not visible from the outside, when the order and reservation of several products/services are being performed, it may be hard for the consumer to manage the information by himself/herself.

In any case, from the view of the consumer performing such as ordering and reserving of products/services, the unavoidable and complicated step-by-step procedures are a bother. On the other hand, from the view of such as an advertisement provider or a ticket issuing agent there may be fear of the consumer's interest to purchase lessening due to the complicated ordering and reserving and the loss of precious sales opportunities, and meanwhile there was also a point that it was unclear whether or not the advertising effect was actually increasing.

### SUMMARY OF THE INVENTION

The present invention is made in view of the above-mentioned conventional problems, and an objective of the present invention is to provide a method for ordering-and-reserving management which is highly convenient for a consumer, suppresses loss of sales opportunities, as well as makes a quick and certain analysis of the advertising effect possible.

A method according to an aspect of the present invention for achieving the above object is, a method for managing, with a server computer, ordering and reserving of printed products/services using a paper medium directed to many and unspecified consumers, such as pamphlets/catalogues/leaflets printed with advertising information regarding such as products/services and attached with a unique code, the method including:

a code-receiving procedure for receiving, from a reader terminal which performed reading of a unique code attached to the paper medium or an input terminal which received the input of a unique code, the unique code of the paper medium;

a code-authentication procedure for authentication of the validity of the unique code, conducted by, regarding the unique code received from the reader terminal or input terminal, authentication in a data base storing the unique code corresponding to the paper medium, or by requesting authentication to an issuing-and-certification authority which is the origin of the unique code and obtaining the result of the authentication request;

an individual-specific-information-receiving procedure for receiving from the reader terminal or input terminal the requesting event, presented by a consumer through the reader terminal or the input terminal, of ordering and reserving by the consumer regarding the product/service printed on the paper medium, and individual-specific information which can specify the consumer;

a paper medium ticketing procedure, for corresponding in the data base, the consumer specified by the individual-specific-information with the unique code authenticated by the code authentication procedure, as well as recording receiving of an ordering-and-reserving demand by the consumer regarding the printed product/service of the paper medium attached with the unique code; and

a result-sending procedure for sending a result of the ticketing in the paper medium ticketing procedure to the reader terminal or input terminal.

Note that, an RFID chip in the present invention is not limited to the meaning of only a non-contact type IC chip. It is used to include the meaning of an RFID tag, in which the non-contact type IC chip storing such as an individually-allotted ID is appropriately covered by a housing of various materials, shapes and sizes.

### DETAILED DESCRIPTION OF PREFERRED EMBODIMENTS

An embodiment of the present invention is described in detail below with reference to the drawings. FIG. 1 shows an entire structural view showing the relationship of a server computer 10, a code management center 20, a reader terminal/input terminal 30 (hereinafter referred to simply as reader terminal 30), and a providing place terminal 40 provided in a product/service providing place 300, and FIG. 2 is a relational view showing the flow of information handled in the structure shown in FIG. 1. As a background of this embodiment, FIGS. 1 and 2 are referred to together, and the summary is first explained.

A situation is assumed in which a travel agency as a product/service providing agent 100 requests a printing company 200 to manufacture a travel catalogue as a paper medium 50, the printing company 200 receives the issue-and-provision of an RFID chip 60, or a bar code or an RFID chip ID as a unique code from the code management center 20 (issuing-and-certification authority which is the origin of the unique code). In this way the paper medium 50 mounted with the RFID chip 60 recording the ID as the unique code, or the paper medium 50 printed with such as the bar code and numbers as the unique code are manufactured, and the travel agency 200 distributes these to the consumers at shops, the street or the like. Note that, the unique code is a unique in that it does not overlap with the respective paper mediums 50, and are structured by various code sorts typified by such as the bar code, character, number, symbol, diagram or a combination thereof.

In this case, when the consumer takes and looks at the travel catalogue on such as the street, and applies for a reservation of a tour that he/she likes, the reading operation of the unique code attached to the travel catalogue 50 is performed by such as a kiosk terminal or a portable telephone as a reader terminal 30, and a personal computer. Then, a server computer 10, worked by an ASP agent who contracts with various product/service providing agents and intensively executes the order-and-reserve management business regarding the products/services, receives the unique code through a network, performs authentication of the unique code, tour reservation and tour price settlement process by using the code management center 20 and a settling organization 70, and performs correspondence of the reservation-and-settlement completion event and the paper medium 50 in a data base 10a and presents the reservation-and-settlement results in the reader terminal 30 (or recording and presenting the reservation-and-settlement result to the RFID chip 60), thus making the travel catalogue 50 itself into a travel ticket. The consumer takes this travel catalogue 50 to the tour destination such as the hotel which is a product/service providing place 300, and by the providing place terminal 40 arranged there performs confirmation of his/her reservation and receives the service provided thereof.

Of course, the application of the present invention is not limited to only this embodiment which assumes the situation where the travel agency distributes the travel catalogue attached with the unique code to the consumers and the ASP agent conducts the tour reservation management, and it is needless to say that it may be applied to any business situation using a paper medium as publicity, and which needs to perform ordering-and-reserving management of the printed products/services.

The system shown in FIG. 1 receives the unique code attached to the paper medium 50 from the reader terminal 30 through a network such as the Internet; authenticates this unique code and orders and reserves the printed product/service by using the code management center 20 or the settlement organization 70, and performs the price settlement process; and performs presenting and instructing to record in the RFID chip 60 of the reserving-and-settlement completion event in the reader terminal 30. This system is structured by the server computer 10 which makes the travel catalogue 50 itself into a ticket, the code management center 20 which is connected to the server computer 10 through a network such as the Internet and is an issuing-and-certification authority of the bar code or the ID of RFID chip 60 as the unique code, the reader terminal 30 which is used by the consumer performing such as ordering and reserving of the printed products/services on the paper medium 50 such as the travel catalogue, and a providing place terminal 40 which is placed in the providing place of the printed products/services on the paper medium 50.

The server computer 10 is worked by the ASP agent (or the product/service providing agent itself), and takes in the unique code (for example, the ID of the bar code or the RFID chip 60) from the reader terminal 30 through such as the Internet by an appropriate communication device, then requests for an inquiry of this unique code at the code management center 20 and obtains the authentication result, or performs the inquiry operation with the registered code in the data base 10a (i.e. the code management data base 11) provided therein to thus perform authentication. Moreover, if it is necessary, or according to the request of the consumer, product/service information more detailed than that printed on the paper medium 50 is transmitted from a content management data base 12 to the reader terminal 30 and shown to the consumer. Note that, it is better if the code management center 20 is integral with the server computer 10, and the ASP agents can perform the issuing of the unique code to the authentication. Further, the issuing of the unique code may be performed by the printing company of the paper medium or the product/service providing agent.

The code management data base 11 in the data base 10a, for example, is such which receives the unique code information from the code data base 21 in the code management center 20 at an appropriate timing and copies it, and corresponds the unique code described in the paper medium 50 managed by the ASP agent with the unique code originating from the code data base 21 one to one, and records it. The content management data base 12 is a data base storing voice, picture, image and other various information that cannot be transmitted by the paper medium 50, such information being related to the unique code attached to the paper medium 50 and stored.

Further, the server computer 10 is provided with a member data base 13. This member data base 13 suitably obtains personal information of the consumers who are to become members of the ordering-and-reserving service of the products/services using the paper medium 50 provided by a product/service providing agent or an ASP agent through some means such as a receiving and sending enter form on the web screen, electronic mail, mail, hand delivery, telephone or fax; and accumulates and manages the personal information using, for example, the member ID as the key. Besides, the server computer 10 comprises a product management data base 14, and in this data base, for every unique code, ordering and reserving or settlement situation of the product/service corresponding to the relevant unique code, the effective period of the paper medium 50, the distributing area and the like are formed into a record to structure a relational table.

The server computer 10 may of course function as a web server or a mail server. Note that, the code management data base 11, the contents management data base 12, the member data base 13 and the product management data base 14, as the data base 10a, are provided in an appropriate storing device, for example a hard disk or the like, and for example may be intensively integrated in the code management data base 11 using the bar code or the ID of the RFID chip 60 as the key. Or, they may be organically connected to each other by a network and may be effectively operated.

The server computer 10 connects with the settlement organization 70 such as an outside financial organization 70, and performs the settlement process for the price of the printed products/services on the paper medium 50. At that time, various monetary information and the like are exchanged with the settlement organization via the settlement gateway. Of course, when the ASP agent fulfils the role of the settlement organization, there is no problem if the server computer 10 itself bears the settlement business and internally processes everything.

The code management center 20 issues the unique code such as the bar code or the ID of the RFID chip 60, and further issues the RFID chip 60 which has recorded the ID, as well as receives the request of the server computer 10 to perform an authenticity confirmation of the unique code or the paper medium 50 and via the authentication operation of the unique code originating from the reader terminal 30. So to speak, it may be called the unique code issuing and certification authority. The unique code is issued in a one-to-one relationship with the paper medium 50 without overlapping with others, and is stored and managed in the code data base 21.

Similarly, the ID is issued in a one-to-one relationship with the RFID chip 60 without overlapping with others, and is stored and managed in the code data base 21. The issuing of the unique code and the RFID chip 60 such as the bar code or the RFID chip ID, is contracted from such as a printing company 200 receiving the request from the product/service providing agent 100, and such as the unique code may be provided to the printing company 200.

The reader terminal 30 is to be used by the consumers, and is such as a personal computer, a portable telephone which may connect to the Internet, or a kiosk terminal set in a kiosk and may communicate with the server computer 10 through a network, which in any case has a reader function in respect to such as the bar code or the ID of the RFID chip as the unique code. The consumer accesses the server computer 10 using this reader terminal 30, and performs the “ticketing” of the paper medium 50.

Note that, if the above server computer 10 and the code management center 20 can attempt sharing of the unique code therebetween in the data base 10a (i.e. the code management data base 11) and in the code data base 21 while maintaining security and synchronicity, it may be an integral computer or may be organically combined through such as the network. Further, the reader terminal 30 and the providing place terminal 40 are not limited to just a general personal computer, a portable telephone connectable to a network and a kiosk terminal as shown in the figure, but if it is connectable to a network and has a reader function of the unique code, it may be a machine, such as a PDA, a game machine, a digital TV, or a fax machine, provided with any of the computer chips. Additionally, a network which connects at least any of the server computer 10, the code management center 20, the reader terminal 30 and the providing place terminal 40 may use not only the Internet, but also various networks such as a personal computer transmission line, a LAN, and a radio network.

FIG. 3 is an explanatory view showing an image of the paper medium mounting the RFID chip in the embodiment. The paper medium 50 mounted with the RFID chip 60 is assumed to be an image, for example, such as in FIG. 3. As the paper medium 50 printed with the advertisement information 51, there may be considered a travel or hotel catalogue, a concert poster, a mail order catalogue, a car rental catalogue, an advertising paper of shop guides which is inserted in such as the back of a pocket tissue, and all sorts of paper mediums for advertisement. Usually in such a space, there is a product photo or an image view, and a publicity slogan or the like is printed as an advertising information 51. For example, at a lower portion a mark 52 is printed so that the place where the RFID chip 60 is mounted may be determined, and an RFID chip 60 is to be mounted within this mark 52. In this way, by the consumer bringing the paper medium 50 close to the reader terminal 30 with this mark 52 at the center, the reading of the ID of the RFID chip 60 may be more simply and surely executed.

P7

FIG. 4 shows an image of the paper medium attached with the bar code. In this case, the advertising information 51 is printed on the paper medium 50 similarly to when the above RFID chip 60 is mounted. Then, at the lower portion hereof, there is printed a bar code 80 related to the paper medium 50 as the unique code. The consumer brings the paper medium 50 with the bar code 80 in the middle close to the reader terminal 30 such as a bar code reader, to execute the reading of the bar code 80 simply and surely. Further, the input by the consumer or the shop attendant with the reader terminal 30 (as the input terminal) of the code number 81 attached to the bar code 80 is received and reading may be performed.

FIG. 5 is an explanatory view showing a structural example of a memory layout of an RFID chip in the embodiment. Next, the internal portion of the RFID chip 60 is paid attention to. The RFID chip 60 is a so-called non-contact type IC chip, has an antenna inside, and through the antenna electric supply and the reading and writing of data from the reader terminal 30 becomes possible. The structure comprises CPU, RAM, ROM, EEPROM and the like, and the ID is recorded in, for example, a nonvolatile read only ROM or an EEPROM which is nonvolatile and may be electrically rewritten or erased. As shown in the diagram, a memory layout is structured by an ID information, a security information and an IC chip inherent information. ID information is a unique number which is allotted to every RFID chip 60, and the allotting rule may be applied like a JAN code for every type of business or corporate. Security information is data which is generated with a certain logic (for example, RSA, 3DES or the like in a cryptographic key method) based on the ID information, and is used for checking in the prevention of wrong alteration. The IC chip inherent information is, for example recorded in the EEPROM, and may include information inherent to a product such as a product/service name corresponding to the relevant RFID chip 60, as well as performing write in of various information such as individual specific information of the consumer who has performed ordering-and-reservation or settlement.

FIG. 6 is an explanatory view showing an example of a code management table in the embodiment. This code management table is, for example provided in the product management data base 14 or the code management data base 11 of the data base 10a. Here, the unique code is the key, and a name of the product/service providing agent (corporate name) who provides the printed product/service of the paper medium 50, the advertising content of the paper medium 50 (contents), the distributing area of the paper medium 50, the expiration date, the ticketing situation showing whether or not the consumer has a ticket, the date of the ticketing, and the like which corresponds to the code management table, may be the data for forming a record for every unique code. These data are provided by, for example a printing company 200 who manufactured the paper medium 50, and is appropriately accumulated/updated. Further, data of the ticketing situation and the ticketing date is re-written when ticketing is actually performed. For example, the data and the consumer's attribute may be both statistically processed together, and may come into use for marketing analysis to see when and where a person with what attribute reserved which product/service.

FIG. 7 is a flow chart showing the processing procedures of the ordering-and-reservation management method in the embodiment; FIG. 8 is an explanatory view showing an example of screen transitions of the reader terminal with the processing procedure of the ordering-and-reservation management method in the embodiment; and FIG. 9 is an explanatory view showing an example of the screen transitions of the providing place terminal with the processing procedure of the ordering-and-reservation management method in the embodiment. Hereinbelow, the actual procedures of the ordering-and-reservation management method of the present invention are shown together with the screen transitions in the reader terminal 30. For example, in the afore-mentioned code management table in FIG. 6, regarding a tour product with a unique code 00001 and shown as “8 day Paris and Rome trip in early spring” by company ABC, a consumer obtains a relevant travel catalogue (as a paper medium 50) on the grounds of a train station and tries to perform the reservation and settlement of the tour then and there. For example, the consumer brings the relevant travel catalogue close to or on the predetermined portion of the kiosk terminal placed on the grounds of the station as a reader terminal 30 in accordance with the screen display 700 of the kiosk terminal.

Then, the kiosk terminal performs the unique code reading operation of the bar code described in the travel catalogue or the RFID chip 60 mounted on the travel catalogue in the reader portion, and sends the obtained unique code:00001 to the server computer 10 through the network. Or, if the code number or the like described in the travel catalogue is input to the kiosk terminal by the consumer, this is received and sent to the server computer 10.

This is received by the server computer 10 (step s101), an authentication request is made to the code management center 20 to authenticate this unique code:00001 and the authentication result is obtained, or authentication is performed in the code management data base 11 of the data base 10a managed by the server computer 10 (s102). If authentication of this unique code fails here, and the travel catalogue or the RFID chip 60 is false or the unique code:00001 is determined as wrongly rewritten (s103), such notice is sent to the kiosk terminal to be displayed on the screen, and the process ends.

If the authentication succeeds (s103), to confirm the understanding of the consumer regarding the tour product that corresponds to the unique code:00001, as in screen 701, a confirmation display is conducted. Here, when the consumer desires to see the details of the tour product, and clicks such a button, this event is sent to the server computer 10 from the kiosk terminal, and the server computer 10 draws out a contents information regarding the tour product corresponding to the unique code:00001 from the contents management data base 12, and sends it back to the kiosk terminal (s104).

The consumer confirms the attractions of the tour product such as the landscape of the travel destination or the meal contents at the content display screen 702, and further performs situation confirmation regarding the various conditions of the trip. The contents to be confirmed in screen 703 (for example, hotel) is selected by the consumer, and when the selected event is sent to the server computer 10 through the network, the server computer 10 draws out for example the relevant hotel information from the contents management data base 12 and sends this back to the kiosk terminal. The consumer confirms the information regarding the hotel to stay at the travel destination at screen 704, whereupon a decision to reserve is made. When the consumer clicks the reservation button at this screen 704, this reservation-demanding event is sent to the server computer 10.

The server computer 10 receives this (s105), and sends back an enter-request form of individual specific information in accordance with the unique code:00001. The consumer enters the address, name, contact place or member ID in the enter request form displayed in the screen 705 and clicks the OK button. This screen may be a member-registration screen.

The individual specific information input by the consumer is sent from the kiosk terminal to the server computer 10, and is received by the server computer 10 (s106). If a member ID is included in the received individual specific information, the member authentication is performed by the member data base 13, and on the other hand when the member ID is not included, it is considered to be the first time of use and registration to the member data base 13 is performed.

Then, with this individual specific information, if it is considered that the consumer is already a member, or an individual consumer may be specified since the address, the name, the contact place and the like is definite, an enter-request form of settlement information is sent from the server computer 10 to the kiosk terminal. The consumer, in accordance with the instruction of the screen 706 where the enter-request form of the settlement information is displayed, inserts a settlement card such as a credit card or a debit card in possession to a predetermined reader of a kiosk terminal, and enters a card number and a PIN number. This settlement information is received by the server computer 10 from the kiosk terminal (s107), the server computer 10 draws out a price information of the tour product corresponding to the unique code:00001 from for example the contents management data base 12, and attaches it to this settlement information. The settlement information attached with this price information is transferred to the settlement organization 70 via the settlement gateway.

The settlement organization 70 performs authentication of the information regarding the settlement card based on the settlement information received, and then performs the settlement by such as drawing out from a predetermined account of the consumer the price of the tour product which is reserved and is desired settlement by the consumer (s108). If settlement ends normally, in the code management table (or the memory area of the IC chip inherent information of the RFID chip 60), by using the unique code:00001 as the key, the consumer specified by the individual specific information may be made to correspond, for example, by his/her member ID (it may be the entire individual specific information) and may be recorded, the reservation request by the consumer of the tour product is received, and the event that the settlement is complete is recorded (s110). In this way the travel catalogue is recorded with data in which the reservation and settlement has been completed normally by the specific consumer regarding the tour product, and the travel catalogue itself is deemed to be a ticket.

The result of the ticketing is sent to the kiosk terminal from the server computer 10 (s111), the consumer views the display screen 707, and knows that the series of processes from reservation to settlement regarding the tour product has completed smoothly. In the last screen 708, for example it is shown that the travel catalogue has been ticketed, and an appropriate management is urged to the consumer. At this time, for example, appropriate printing letters or printing images such as a shadow picture, a character and letters showing that the ticketing of the travel catalogue is complete may be transmitted to the kiosk terminal by the server computer 10, and a printing instruction to print out the printing letters or print data to the travel catalogue, may be sent to a printing facility provided within or connected to the kiosk terminal.

P11

The consumer heads for the travel destination with the travel catalogue which has been ticketed, and arrives at, for example the destination hotel of the tour (product/service providing place 300). The consumer places the travel catalogue near or on the providing place terminal 40 which has a similar function as the kiosk terminal and is provided in such as the lobby of the hotel. The instruction screen at that time is screen 800. The providing place terminal 40 conducts reading of the bar code or the RFID IC chip 60 mounted on the relevant travel catalogue and authenticates the unique code, and requests authentication of the unique code:00001 to the server computer through the network.

In the server computer 10, authentication at the code management center 20 and the code management data base 11 similar to the above regarding this unique code:00001 is performed, and if authentication is OK, the result is sent back. Or, the reservation-and-settlement contents corresponding to the unique code:00001 is drawn out from the code management table and is sent back. At the providing place terminal 40, with this authentication result, such as the name of the consumer, the reserved room number and the days of stay are displayed at the screen 801. On the other hand, if unique code authentication fails, such notice is sent back to the providing place terminal 40, and a display saying that there is no reservation at screen 802 is performed and the process is completed.

As described above, when various consumers perform multiple reservations and settlements of multiple products/services such as tour products using the paper medium 50 of such as a travel catalogue, the consumption record is accumulated in the code management table of the server computer 10. This record becomes data which may be effectively used in the field of marketing. It is suitable to compare the information of the paper medium 50, such as the distribution area, the distribution period, the distributed subjects, the distributed amount, with the content of the advertisement information which are accumulated in the code management table, and the attribute of the consumer identified from the individual specific information regarding the consumer who performed the ordering-and-reserving of the printed product/service through this paper medium, and to analyze the advertising effect regarding the paper medium.

According to the present invention, an ordering-and-reserving management method which is excellent for the convenience of the consumer, suppresses loss of sales opportunities, and can make quick and sure analysis of the advertising effects possible, may be provided.

Although the preferred embodiment of the present invention has been described in detail, it should be understood that various changes, substitutions and alternations can be made therein without departing from the spirit and scope of the inventions as defined by the appended claims.

### BRIEF DESCRIPTION OF THE DRAWINGS

For a more complete understanding of the present invention and the advantages thereof, reference is now made to the following description taken in conjunction with the accompanying drawings wherein:

FIG. 1 is an entire structural view showing the relationship of a code management center, a server computer, a reader terminal and an input terminal, and a providing place terminal in an embodiment of the present invention;

FIG. 2 is a relational view showing the flow of information handled in a structure shown in FIG. 1;

FIG. 3 is an explanatory view showing an image of a paper medium mounted with an RFID chip in the embodiment;

FIG. 4 is an explanatory view showing an image of a paper medium attached with a bar code in the embodiment;

FIG. 5 is an explanatory view showing a structural example of a memory layout of the RFID chip in the embodiment;

FIG. 6 is an explanatory view showing an example of a code management table in the embodiment;

FIG. 7 is a flow chart showing process procedures of an ordering-and-reserving management method in the embodiment;

FIG. 8 is an explanatory view showing screen transition examples of a reader terminal with the process procedures of the ordering-and-reserving management method in the embodiment; and

FIG. 9 is an explanatory view showing the screen transition examples of a providing place terminal with the process procedures of the ordering-and-reserving management method in the embodiment.

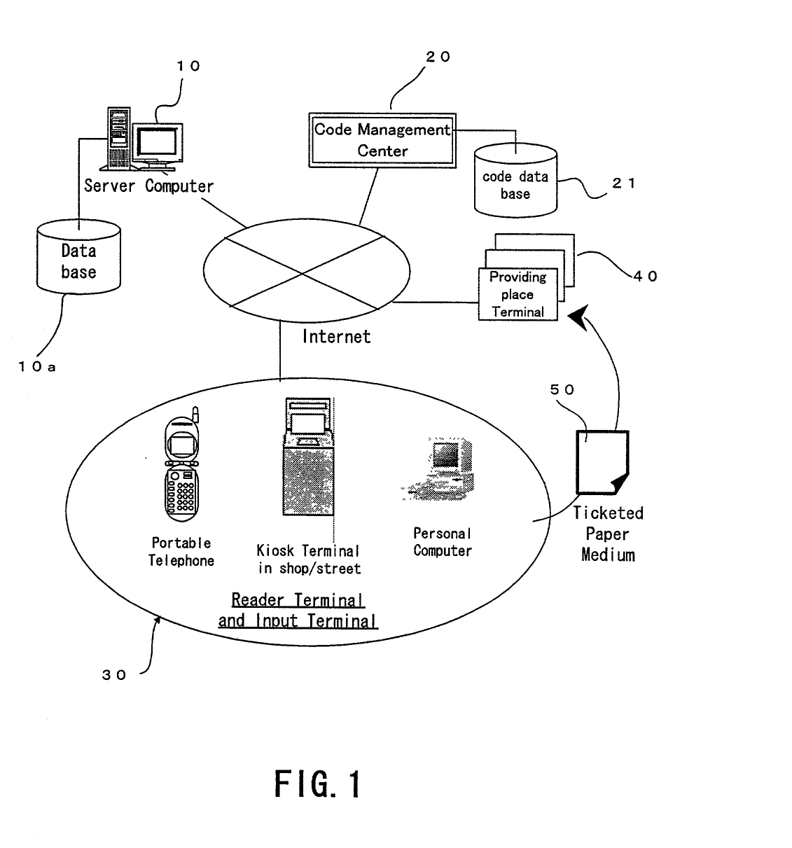

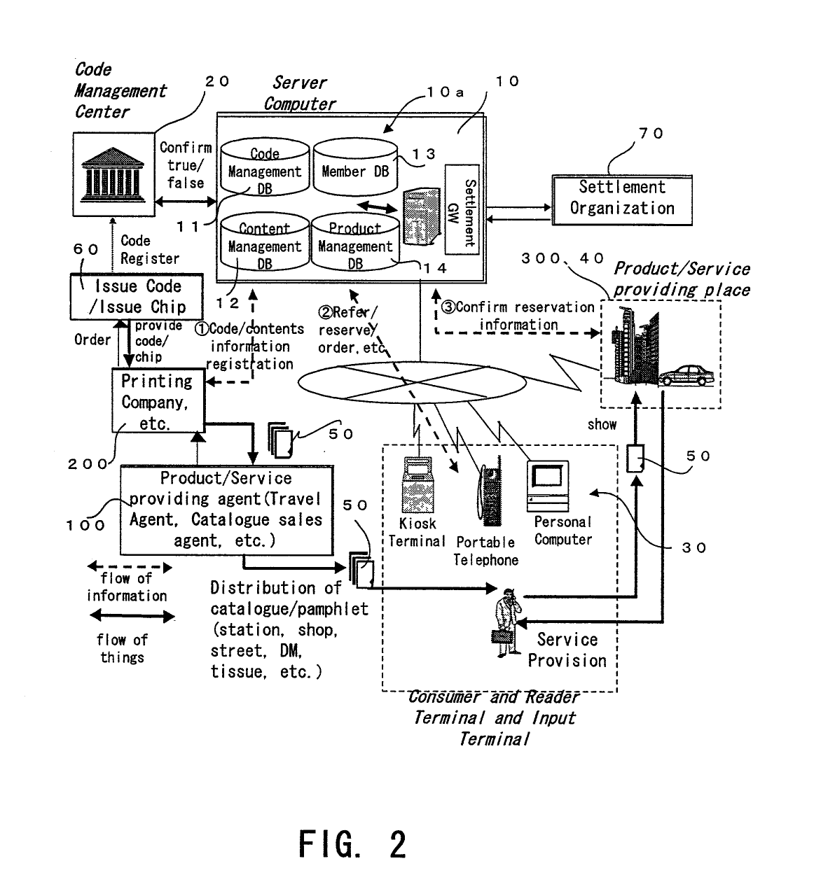

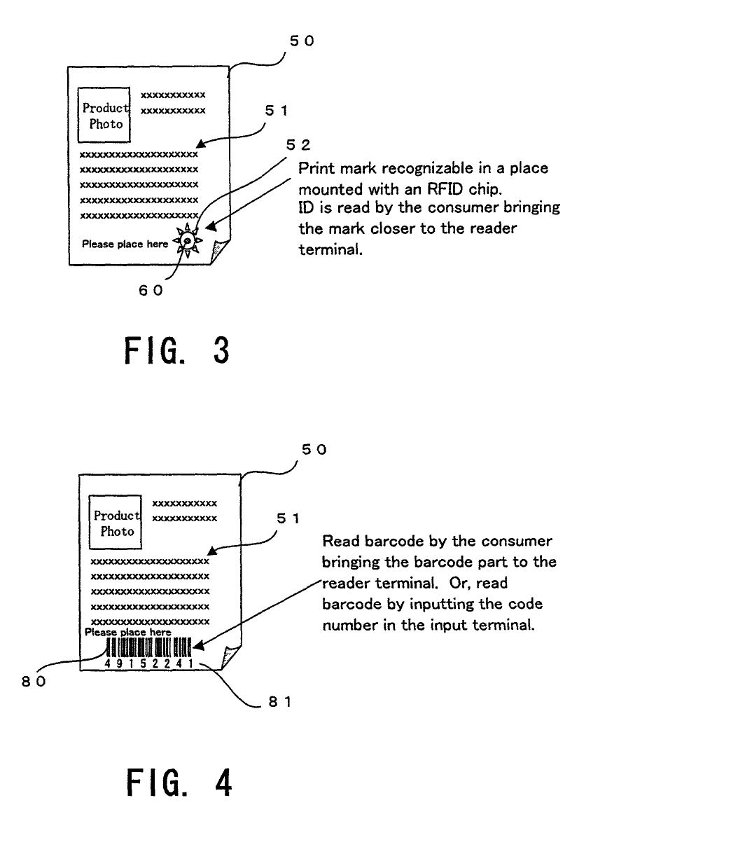

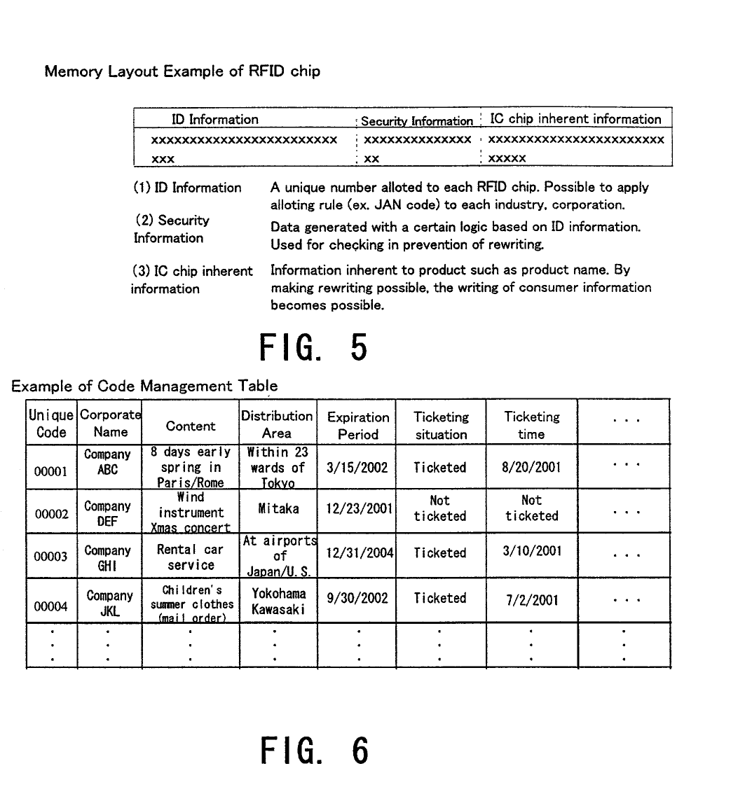

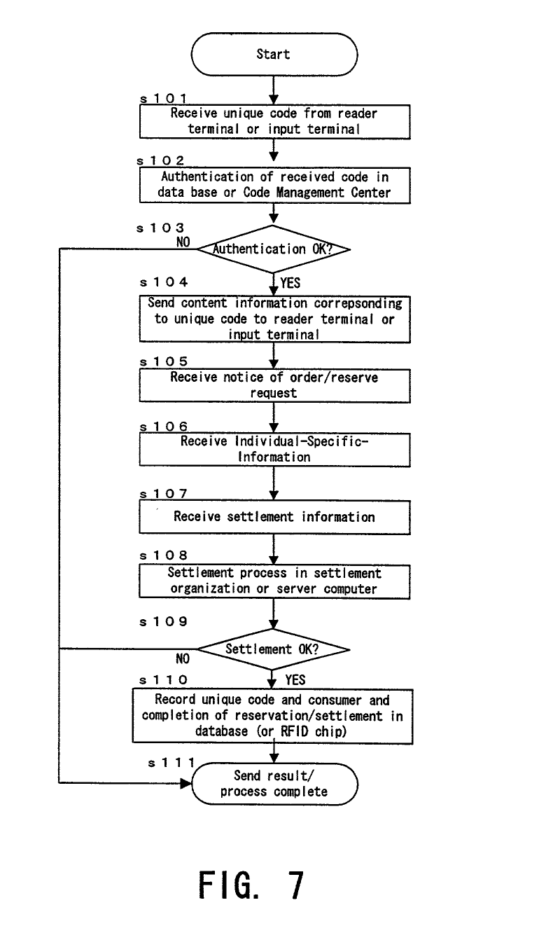

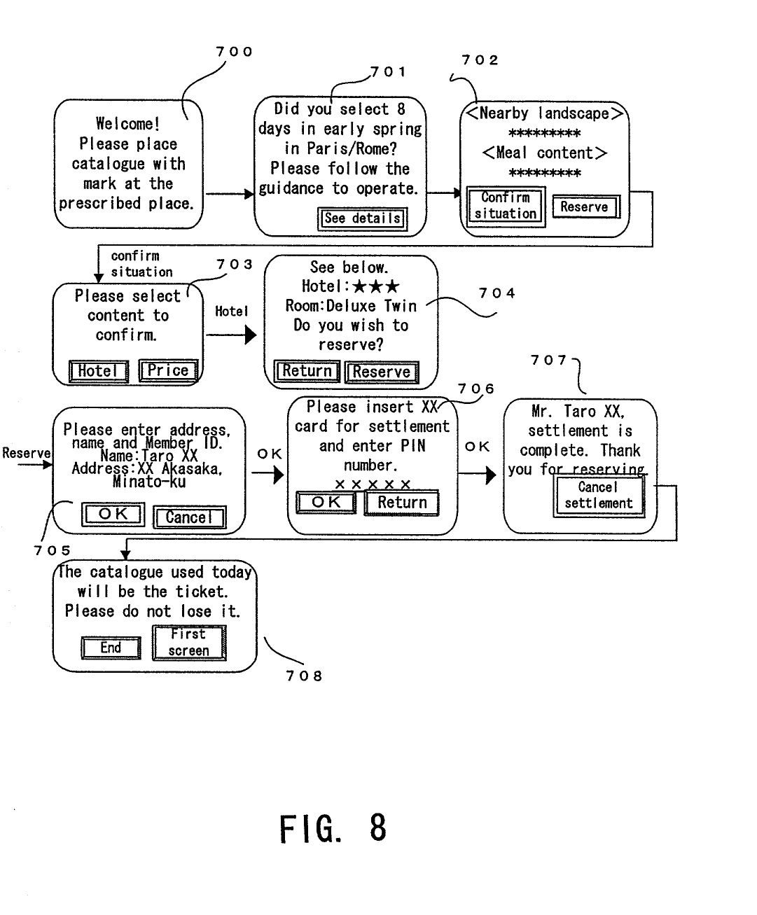

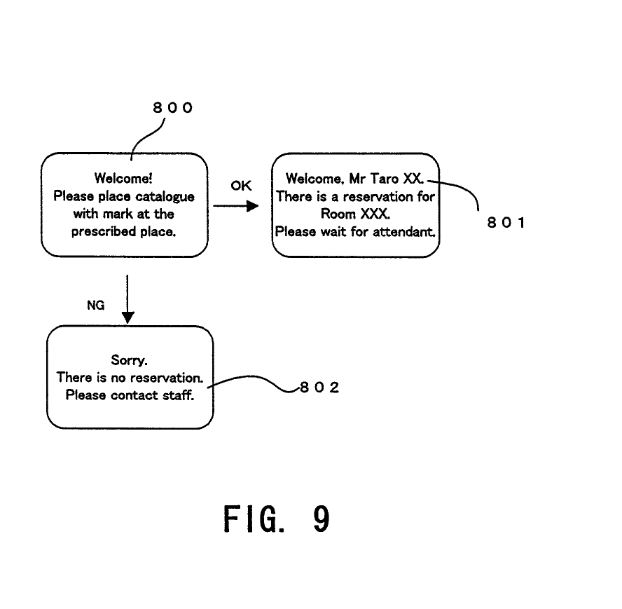

What is claimed is:

1. A method for managing, with a server computer, ordering and reserving of printed products/services using a paper medium directed to many and unspecified consumers, such as pamphlets/catalogues/leaflets printed with advertising information regarding such as products/services and attached with a unique code, the method including:
a code-receiving procedure for receiving, from a reader terminal which performed reading of the unique code attached to said paper medium or an input terminal which received the input of the unique code, the unique code of the paper medium;
a code-authentication procedure for authentication of the validity of the unique code, conducted by, regarding the unique code received from said reader terminal or input terminal, authentication in a data base storing the unique code corresponding to said paper medium, or by requesting authentication to an issuing-and-certification authority which is the origin of said unique code and obtaining the result of the authentication request;
an individual-specific-information-receiving procedure for receiving from said reader terminal or input terminal the requesting event, presented by a consumer through said reader terminal or said input terminal, of ordering and reserving by the consumer regarding the product/service printed on said paper medium, and individual-specific information which can specify the consumer;
a paper medium ticketing procedure, for corresponding in said data base, the consumer specified by the individual-specific information with the unique code authenticated by said code authentication procedure, as well as recording receiving of an ordering-and-reserving demand by the consumer regarding the printed product/service of the paper medium attached with said unique code; and
a result-sending procedure for sending a result of the ticketing in said paper medium ticketing procedure to said reader terminal or input terminal.

2. A method as claimed in claim 1, characterized by including:
a settlement-information-receiving procedure for receiving, from said reader terminal or said input terminal, the settlement information originating from the consumer such as a card number and PIN number thereof of various cards owned by the consumer and having a settlement function, or an account number or a PIN number thereof of a settlement account;
a settlement-process procedure, in the server computer or a computer of a settlement organization which is connected with said server computer, for settlement processing of the price of said printed product/service ordered and reserved by the consumer, based on said received settlement information;
a ticket settling procedure, in said data base, for corresponding the consumer with said unique code and recording a completion event of said settling-process procedure; and
a settlement-result-sending procedure for sending the result in said ticket-settling procedure to said reader terminal or input terminal.

3. A method as claimed in claim 1 wherein said settlement information is included in said individual-specific information, and said settlement-information-receiving procedure is included in said individual-specific-information-receiving procedure.

4. A method as claimed in claim 1 wherein said ticket-settling procedure is included in said paper medium ticketing procedure.

5. A method as claimed in claim 1 wherein appropriate printing letter and print data indicating that said paper medium ticketing procedure or said ticket-settling procedure is completed, is sent to said reader terminal or input terminal mounted on a printer or connected thereto or having a printer function, and instruction to print to said paper medium is performed.

6. An advertising-effect-analysis method wherein: a distribution information, including any of a distribution area, a distribution period, a distributed subject, a distributed number, and a content of the advertising information of said paper medium, is recorded in said data base while being related with a unique code mounted on the paper medium; an attribute of a consumer, determined from said individual specific information regarding the consumer performing the ordering and reserving of the printed product/service through said paper medium, is compared with said distribution information corresponding to the unique code used for ordering and reserving by the consumer; and an advertising effect regarding said paper medium is analyzed.

7. A system realized by one or more computers executing managing of ordering and reserving of products/services using a paper medium directed to many and unspecified consumers, such as pamphlets/catalogues/leaflets, printed with advertising information regarding such as said products/services and attached with a unique code, the method including:
code-receiving means for receiving the unique code of the paper medium, from a reader terminal performing a reading operation of the unique code attached to said paper medium or an input terminal receiving the input of the unique code;
code-authentication means for authentication of the validity of the unique code, conducted by, regarding the unique code received from the reader terminal or the input terminal, authentication in a data base storing the unique code corresponding to said paper medium, or by requesting authentication to an issuing-and-certification authority which is the origin of said unique code and obtaining the result of the authentication request;
individual-specific-information-receiving means for receiving from said reader terminal or input terminal the requesting event, presented by a consumer through said reader terminal or said input terminal, of ordering and reserving by the consumer regarding the product/service printed on said paper medium, and individual-specific information which can specify the consumer;
paper medium ticketing means, for corresponding in said data base, the consumer specified through the individual-specific information with the unique code authenticated by said code-authentication procedure, as well as recording receiving of an ordering-and-reserving demand by the consumer regarding the printed product/service of the paper medium attached with said unique code; and
result-sending means for sending a result of the ticketing in said paper medium ticketing procedure to said reader terminal or input terminal.
